(19) United States
(12) Patent Application Publication
(10) Pub. No.: US 2010/0288695 A1
(43) Pub. Date: Nov. 18, 2010

(54) PROCESS AND SYSTEM FOR ALGAE PRODUCTION FROM THE BYPRODUCTS OF WASTE WATER TREATMENT

(76) Inventor: Thomas ST. LAWRENCE, Lake Jackson, TX (US)

Correspondence Address: EGBERT LAW OFFICES, 412 MAIN STREET, 7TH FLOOR, HOUSTON, TX, 77002, US

(21) Appl. No.: 12/464,606

(22) Filed: May 12, 2009

(51) Int. Cl. C02F 3/32

(52) U.S. Cl. 210/602; 210/151

(57) ABSTRACT

A system for algae production has a first tank with an interior containing aerobic bacteria and waste water therein, a first aerator cooperative with the interior of the first tank for passing bubbles into the waste water and the aerobic bacteria in the interior of the first tank, a first collection chamber positioned above the first tank so as to collect carbon dioxide from a reaction of the aerobic bacteria with the waste water, a second tank having an interior containing algae and water therein, and a second aerator in fluid communication with the first collection chamber. A second aerator serves to pass carbon dioxide from the first collection chamber as mini microbubbles into the algae and water of the second tank. A second collection chamber is positioned above the second tank so as to collect oxygen produced from the algae. The second collection chamber is in fluid communication with the first aerator.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to process and systems for producing algae. Additionally, the present invention relates to processes and systems for treating waste water. Additionally, the present invention relates to methods for enhancing the production of algae from carbon dioxide as produced by a waste water treatment process.

2. Description of Related Art Including Information Disclosed Under 37 CFR 1.97 and 37 CFR 1.98.

Algae have been cultivated artificially for such diverse purposes as the production of food for animals and humans, the treatment of sewage and waste waters, and the accumulation of radioactive wastes. More recently, algal cultures have been used for the production of enzymes having industrial and research applications and for producing oils and other materials having nutritional value. Modern biotechnology offers an opportunity for the genetic modification of algae to yield cultures capable of producing a wide variety of useful materials.

Various methods and equipment have been employed for the artificial culturing of algae. Perhaps the simplest procedures have involved the use of shallow open ponds exposed to sunlight. Such ponds are subject to contamination by dust, other microorganisms, insects and environmental pollutants and provide minimal ability to control the degree of exposure to light, temperature, respiration and other important factors. A more sophisticated approach has involved growing algal cultures in plastic-covered trenches and ponds, optionally having electrically powered pumps and agitators. These configurations reduce the chances of contamination of the culture and permit more accurate control of temperature, respiration and other parameters.

Modern photobioreactor structures are constructed to optimize the photosynthetic process by providing a means for uniformly exposing the cells in the algal culture to the optimum amount of visible light. To accomplish this, prior photobioreactors have been built with sources of light mounted in the photobioreactor, immersed in the algal culture. Sources of light have included fluorescent tubes or optical rods. The light sources are positioned inside the photobioreactor taking into consideration such characteristics as the cell density and light path length.

The principal nutrient required for the algal culture in the photosynthesis process is inorganic carbon. In known photobioreactor systems, the algal cultures obtain their carbon from carbon dioxide, often bubbled through the culture medium. The carbon dioxide is often introduced in the medium through sparging tubes or other suitable means positioned near the bottom of the photobioreactors. The bubbling of the carbon dioxide often serves a dual function in that it aids in the circulation of the algal culture.

Unfortunately, the costs and procedures associated with providing carbon dioxide for enhancing the growth of algae can be quite expensive and energy intensive. As such, the net fuel benefit of the algae production may be less than the cost of actually producing the requisite carbon dioxide for the growth of the algae. Additionally, the systems require the storage and delivery of carbon dioxide. This can be quite difficult and labor intensive. As such, a need has developed so as to be able to conveniently, easily and inexpensively produce carbon dioxide in order to enhance the growth of algae.

Additionally, the oxygen byproducts that result from the production of algae are often dissipated into the atmosphere. As such, this otherwise useful oxygen is needlessly wasted. A need has developed whereby the oxygen produced from the growth of algae can be utilized in waste water treatment systems for the effective treatment of the waste water.

In the past, various patents have issued relating to algae production. For example, U.S. Pat. No. 3,768,200 issued on Oct. 30, 1973 to J. W. Klock, describes an apparatus for the production of algae. In this apparatus, waste-containing liquor is biochemically treated in a tank by continuously circulating it through a filter media containing quantities of aerobic bacteria. After a quantity of the waste material is removed, the remaining liquor is directed to and circulated in an algae growth tank.

U.S. Pat. No. 4,044,500, issued on Aug. 30, 1977 to D. O. Hitzman, describes an integrated fermentation-photosynthesis biomass process. A fermentation is conducted to produce cells which are recovered. The effluent from the fermentation is used for cultivation of algae with the carbon dioxide produced in the fermentation step being circulated to the algae production step.

U.S. Pat. No. 4,084,346, issued on Apr. 18, 1978 to Stengel et al., teaches a method and arrangement for optimally supplying autotrophic organisms with carbon dioxide. Carbon dioxide is introduced into a culture channel and regulated in response to the measured pH. A suspension of the organisms can be moved in one direction. A discharge in the channel introduces carbon dioxide into the suspension.

U.S. Pat. No. 4,324,068, issued on Apr. 13, 1982 to M. L. Anthony, discloses a process for the production of algae. In this patent, algae yield in a body of aqueous nutrient solution is increased by means of a nutrient thin-film surface culture substrate cycling between an illumination area and a non-illuminated refractory area in a closed system. The algae feeds on the nutrient solution and carbon dioxide.

U.S. Pat. No. 4,473,970, issued on Oct. 2, 1984 to B. C. Hills, describes a method for growing a biomass in a closed tubular system. The medium containing the biomass fills one-half of the enclosure and a carbon dioxide and air layer is above the medium and fills the other one half. The biomass is grown in the medium within the enclosure in a predetermined growing cycle enhancing growth of the biomass by exposing it to continuous agitation, heat and illumination. The carbon dioxide consumed from the medium and gaseous layer during photosynthesis in the biomass is continuously replenished by carbon dioxide and oxygen.

U.S. Pat. No. 5,151,347, issued on Sep. 29, 1992 to Delente et al., provides a closed photobioreactor. The closed photobioreactor contains a photosynthetic culture in a substantially sealed environment and provides a system for recirculating the reactant gas through the culture. The closed loop system can be operated with carbon isotopes. The system also removes the molecular oxygen produced in the photosynthesis reaction from the closed photobioreactor.

U.S. Pat. No. 5,659,977, issued on Aug. 26, 1997 to Jensen et al., teaches an integrated micro algae production and electricity cogeneration. A fossil fuel engine produces hot exhaust gas from which sensible heat dries the algae. Carbon dioxide from the exhaust gas is recovered for use as a nutrient in the micro algae production plant. Electrical energy from the generator is used to drive motors and/or produce artificial illumination and/or drive pumps, motors and controls in the micro algae production plant.

U.S. Pat. No. 6,156,561, issued on Dec. 5, 2000 to Kodo et al., discloses a system and method for culturing algae. The system comprises a culture pool for exposing a culture fluid containing the algae to sunlight, a culture tank having a larger depth than the culture pool, a supply unit for supplying the culture fluid from the culture pool to the culture tank, and at least one filter for removing grown algae from the culture fluid overflowing from the culture tank to the culture pool. A filtrate containing immature algae is returned to the culture pool. The system comprises a unit for mixing carbon dioxide gas in the culture fluid to be supplied in the culture tank. A lighting unit is disposed in the culture tank to provide an artificial light to the culture field.

U.S. Patent Publication No. 2007/0289206, published on Dec. 20, 2007 to M. G. Kertz, describes a method and apparatus for sequestering carbon dioxide by using algae. This apparatus comprises a plurality of vertically suspended bioreactors. Each bioreactor is translucent and includes a flow channel formed by a plurality of baffles. A culture tank contains a suspension of water and at least one algae. A plurality of gas jets introduce carbon dioxide containing gas into the suspension. The culture tank is in fluid communication with an inlet in each channel for flowing the suspension through the channel in the presence of light.

U.S. Provisional Patent No. 61/055,716, filed on May 23, 2008 to the present inventor, describes a system for forming mini microbubbles. In this provisional application, the system includes a drive means, a shaft attached to the drive means, a displacing means attached the shaft, a discharge plate positioned proximate the displacing means, at least one housing adjustably attached to the discharge plate and at least one media chamber fluidly connected with the discharge plate. The discharge plate has at least one discharge hole. The media chamber is fluidly connected to the discharge hole of the discharge plate. The housing surrounds the displacing means so as to control the flow of liquid and media to optimally mix and produce mini microbubbles. The housing is configured so as to create a turbulence of fluid in proximity to the rotating means. The housing is positioned at an optimal distance from the discharge plate for optimally mixing liquid and media to make mini microbubbles.

The use of microbubbles filled with atmospheric air has been used to provide an effective treatment for beneficial aerobic microbial remediation. The liquid under treatment can have conditions requiring mixing, quiescence, or a combination thereof. When larger bubbles are formed, they rapidly rise to the surface of a liquid and increase in volume as the liquid pressure decreases while the bubbles rise. These larger bubbles may be captured at various depths and reprocessed into smaller bubbles. Smaller bubbles remain in liquid for a longer period of time, impart less mixing and are moved by eddy currents and the Brownian movement of liquids. A mini microbubble is smaller than a microbubble, remains in liquid longer than a microbubble, and imparts a milky appearance to liquids. Mini microbubbles easily flow, rapidly diffuse, and linger within a liquid. Because gas transfer to liquids is a function of the ratio of surface area to volume, the smaller mini microbubbles have a greater transfer potential and are better for aeration.

It is an object of the present invention to provide a system for the production of algae that effectively introduces carbon dioxide to the algae.

It is another object of the present invention to provide a system and method for the production of algae which uses the gaseous byproducts of waste water treatment for introduction to the algae.

It is another object of the present invention to provide a system and method for the production of algae which uses the oxygen byproduct of the algae as aerated oxygen for the waste water treatment plant.

It is a further object of the present invention to provide a method for the production of algae which increases the production of algae hydrocarbons from the algae.

It is still another object of the present invention to provide a system and method for the production of algae which enhances the ability to effectively treat waste water.

It is still a further object of the present invention to provide a system and method that utilizes mini microbubbles to optimize waste water treatment and algae production.

These and other objects and advantages of the present invention will become apparent from a reading of the attached specification and appended claims.

### BRIEF SUMMARY OF THE INVENTION

The present invention is a system for algae production that comprises a first tank having an interior containing aerobic bacteria and waste water therein, a first aeration means cooperative with the interior of the first tank for passing bubbles into the waste water and the aerobic bacteria, a first collection chamber positioned above the first tank so as to be suitable for collecting carbon dioxide from a reaction of the aerobic bacteria with the waste water, a second tank having an interior containing algae and water therein, and a second aeration means in fluid communication with the first collection chamber so as to pass carbon dioxide from the first collection chamber as bubbles into the algae and the water of the second tank.

The first tank has an inlet connected thereto so as to pass waste water into the interior of the first tank. The first tank has an outlet connected thereto so as to pass treated effluent from the first tank.

The first aeration means serves to pass mini microbubbles into the waste water and aerobic bacteria in the interior of the first tank.

A second collection chamber is positioned above the second tank. The second collection chamber collects oxygen produced from the algae in the interior of the second tank. The second collection chamber is in fluid communication with the first aeration means. The first aeration means serves to pass bubbles of oxygen into the waste water and aerobic bacteria in the interior of the first tank. The second tank has an outlet connected thereto so as to pass algae solids from the interior of the second tank. The second aeration means passes mini microbubbles of carbon dioxide into the algae and water in the interior of the second tank.

The first aeration means is supported by a float on a surface of the waste water in the first tank. The second aeration means is supported by a float on a surface of the water in the second tank.

The present invention is also a process for algae production that comprises the steps of: (1) reacting waste water with aerobic bacteria and oxygen so as to produce carbon dioxide; (2) passing the produced carbon dioxide into water having algae therein so as to grow the algae; and (3) removing the grown algae from the water.

In this method, oxygen is collected from the algae and then mixed with the waste water and aerobic bacteria. The carbon dioxide is passed as mini microbubbles of the produced carbon dioxide into the water with the algae therein. The produced the carbon dioxide is collected into a collection chamber, the collection chamber is connected to an aerator, and the algae and water is aerated with the collected carbon dioxide.

### BRIEF DESCRIPTION OF THE SEVERAL VIEWS OF THE DRAWINGS

FIG. 1 is a diagrammatic illustration of the system and method of the present invention.

FIG. 2 is a cross-sectional view of the aeration means of the present invention as used for the production of mini microbubbles to the waste water treatment tank and the algae tank of the present invention.

### DETAILED DESCRIPTION OF THE INVENTION

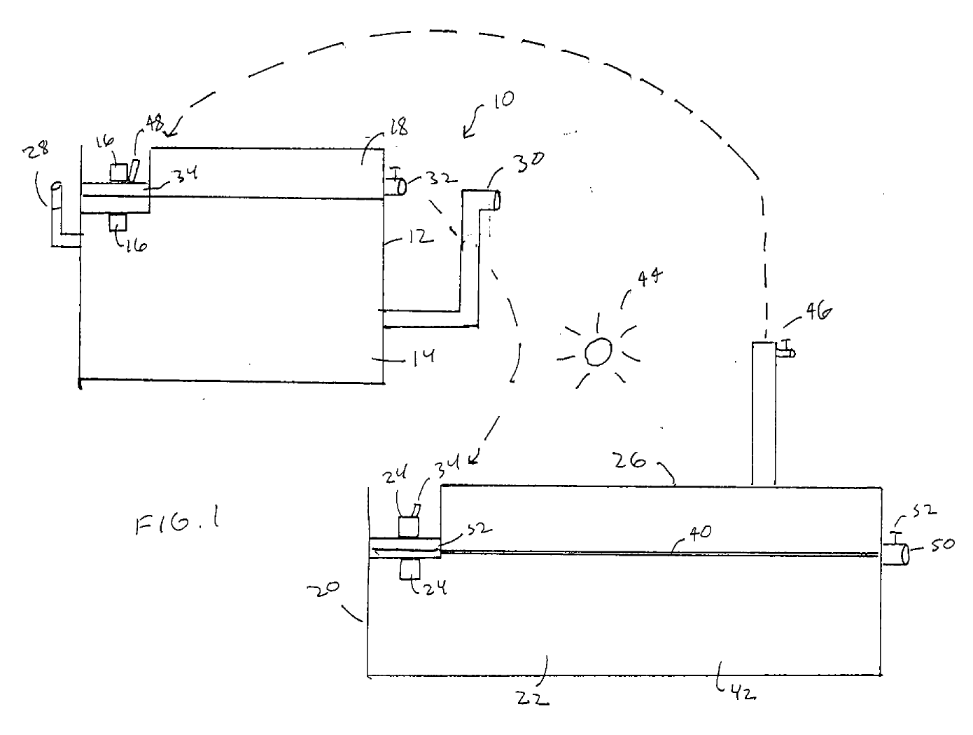

FIG. 1 illustrates the system and method of the preferred embodiment of the present invention. The system 10 for algae production in accordance with the teachings of the present invention includes a first tank 12 having aerobic bacteria and waste water in an interior 14 of the first tank 12. A first aerator 16 is cooperative with the interior 14 of the first tank 12 so as to pass bubbles into the waste water and aerobic bacteria in the first tank 12. A first collection chamber 18 is positioned above the first tank 12 so as to collect carbon dioxide from the reaction of aerobic bacteria with the waste water. A second tank 20 has an interior 22 containing algae and water therein. A second aerator 24 is in fluid communication with the first collection chamber 18 so as to pass carbon dioxide from the first collection chamber 18 as bubbles into the algae and water within the interior 22 of the second tank 20. A second collection chamber 26 is positioned above the second tank 20 so as to collect oxygen as produced from the algae in the interior 22 of the second tank 20. The second collection chamber 26 is in fluid communication with the first aerator 16 so as to deliver oxygen to the first aerator 16.

In FIG. 1, it can be seen that the first tank 12 has an inlet 28 that opens to the interior 14. The inlet 28 allows untreated waste water to be introduced to the aerobic bacteria within the interior 14 of the first tank 12. An outlet 30 is communication with the interior 14 of the first tank 12. The outlet 30 allows treated effluent to be removed from the interior 14 of the first tank 12. Because solids will settle at the bottom of the first tank 12 and oils will rise to the top of the first tank 12, water will naturally leave the first tank 12 when the outlet 30 has a gooseneck configuration. As is well known in the art, the reaction of oxygen with aerobic bacteria allows waste water to be properly treated. A byproduct of the treatment process is the release of carbon dioxide gas. Since the first collection chamber 18 is positioned above the first tank 12, the carbon dioxide can be produced naturally so as to be collected within the first collection chamber 18. The first collection chamber 18 has an outlet 32 so as to allow the collected carbon dioxide gas to be passed therefrom to the inlet 48 of the second aerator 24.

The first tank 12 has the aerator 16 in a position adjacent to the collection chamber 18. The aerator 16 is supported on a float 34 which will float on the surface of the waste water within the interior 14 of the first tank 12. The relationship between the float 34 and the collection chamber 18 will create a sealed cover over the top of the first tank 12 so that the carbon dioxide gas can be effectively collected. If the collection from the algae is insufficient to properly supply the aerobic bacteria in the first tank 12, then additional atmospheric air can be introduced by the aerator 16 into the mixture of aerobic bacteria and waste water.

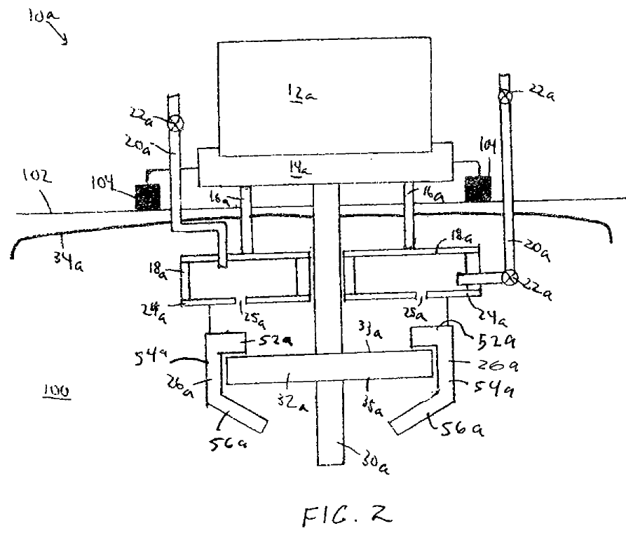

In the present invention, the aerator 34 is a vacuum bubble aerator that effectively produces vacuum bubbles and/or mini microbubbles into the waste water within the interior 14 of first tank 12. These vacuum bubbles and/or mini microbubbles will remain in suspension for a very long period of time so that the surface area of the mini microbubbles is maximized for ultimate distribution and contact with the aerobic bacteria in the waste water. A system for the production of such mini microbubbles is described in U.S. Provisional Patent Application Ser. No. 61/055,716 by the present inventor. The system is described herein in connection with FIG. 2.

The second tank 20 is generally elongated so as to maximize a surface area of the water within the second tank 20. The algae 40 will generally reside adjacent to the surface of the water 42 within the interior 22 of second tank 20. The second collection chamber 26 is positioned above the algae 40 within the second tank 20. The second collection chamber 26 can be in the nature of a flexible sheet of transparent plastic that overlies the surface of the water 42. This transparent sheet of plastic will allow sunlight 44 to effectively carry out the photosynthesis process of the algae 40. In other circumstances, a clear rigid polymeric cover can also be placed over the algae 40 within the tank 20 so that proper photosynthesis can occur. In any event, a suitable volume within the interior of the second collection chamber 26 should exist so that appropriate quantities of oxygen can be produced and collected. The second collection chamber 26 includes an outlet 46 at a top surface thereof. Outlet 46 is connected to the inlet 48 of the aerator 16 so that generated enriched oxygen can be delivered as mini microbubbles into the aerobic bacteria and waste water within the interior 14 of tank 12. The outlet 46 is in the form of a tube which rises a distance about the second tank 20 suitable for preventing carbon dioxide bubbles from mixing with the oxygen bubbles. The outlet 46 can be valved so as to control the amount of oxygen that is delivered to the aerator 16.

The second tank 20 has an outlet 50 at an end thereof opposite the aerator 24. Outlet 50 allows algae solids to be removed from the interior 22 of the second tank 20. A valve 52 can be associated with the outlet 50 so as to control the algae solids from the interior 22 of the second tank 20.

The aerator 24 is supported upon the surface of the water 42 within the second tank 20 by a suitable float 52. Float 52 is joined to the collection chamber 26 so as to produce a generally air-tight cover over the algae 40 within the second tank 20. The aerator 24 is also in the nature of a vacuum bubble aerator so that vacuum bubbles and/or mini microbubbles of carbon dioxide can be introduced into the water 42 so as to enhance the growth of the algae 40. A description of this vacuum bubble aerator is described herein in connection with FIG. 2. It is known that algae grows at a more rapid rate when carbon dioxide is introduced thereto.

Referring to FIG. 2, there is shown a side cross-sectional view of the vacuum bubble aerator 10a as used in the present invention. The drive means is a fractional horsepower electrical motor 12a that sits on a support 14a. A shaft 30a is attached to the motor 12a and extends vertically downwardly into the liquid 100. Numerous other methods can be used to power shaft 30a, such as various types of electrical, pneumatic, hydraulic and wind powered motors that have been combined with direct, belt, chain and magnetic drives. The support 14a is held above the surface 102 of the liquid 100 by floats 104. The shaft 30a is almost entirely submerged in the liquid 100. Two chambers 18a are attached to the support 14a by support brackets 16a. The chambers 18a are directly connected to the discharge plates 24a so that media in the chambers 18a can flow through discharge holes 25a of the discharge plates 24a. Media is supplied to the chambers 18a by lines 20a. Lines 20a can have valves 22a so as to regulate the flow of media from a media supply (not shown) to the chambers 18a.

The displacing means 32a is located below the discharge plate 24a on the shaft 30a. The displacing means can be any suitable device for displacing a liquid and mixing it with a media. For example, the displacing means 32a can be an impeller, a propeller, or a louvered disc. A housing 26a is positioned around the displacing means 32a. The housing 26a is configured so as to create a turbulent flow of media and liquid in proximity of the displacing means 32a within the housing 26a. The housing 26a is adjustably attached to the discharge plate 24a. Thus, the housing 26a can be moved towards or away from the discharge plate 24a so as to optimize mini microbubble formation in the system 10a of the present invention. A recycling dome 34a is positioned above the chambers 18a in the fluid 100 so as to catch large bubbles and recycle them back through the system 10a so as to create mini microbubbles.

Referring still to FIG. 2, the system 10a is supported by the floats 104. Moreover, the motor 12a is above the surface 102 of the liquid 100. The motor 12a can be submerged below the surface 102 of the liquid 100. The shaft 30a can extend at any angle in relation to the motor 12a. The system 10a can be above the surface 102, partially submerged, or completely submerged within the liquid 100.

The displacing means 32a has a first side 33a and a second side 35a. The rotation of the displacing means 32a about the axis of the shaft 30a causes fluid displacement in the area between the discharge plate 24a and the displacing means 32a and causes a partial vacuum pressure to exist in that area, called the equalization area.

The adjustable and configurable housing 26a is in proximity of the discharge plate 24a. The housing 26a surrounds the displacing means with inlet and outlet controls and regulates liquid flow. The housing 26a may be adjusted to any position relative to the discharge plate 24a so as to reach a specific bubble control objective for its corresponding depth. The equalization area is further described by the space bounded by the area within and below the housing 26a and the distance between the discharge plate 25a and the first side 33a of the displacing means. The housing 26a has a top restrictor 52a, a sidewall 54a, and a bottom restrictor 56a. The shape of the housing 26a around the displacing means 32a provides an enclosure that has significant control and impact on the resulting bubble control. Most often a shape is similar to that of the cross section of the displacing means 32a so as to produce optimal results. The housing 26a of FIG. 2 could also be shaped to be a simple cylindrical housing with a top restrictor to restrict inflow. Changing the angle of the top restrictor 52a with respect to the side wall 54a of the cylinder-shaped housing 26a creates a backpressure against the liquid discharge by adjusting the percent closed. This interaction using back pressure against the displacement can also cause more lateral discharge. The circulating axial vortices appear to reprocess larger bubbles into smaller ones. A simple ninety degree baffle has provided an adequate result; however, a more refined angular approach has often yielded a better result with less energy expended.

The recycling dome 34a above the displacement means 32a and housing 26a captures larger, more buoyant bubbles as they rise, returning and reprocessing them in the system 10a. The recycling dome 34a can be curved or straight so long as it can contain captured bubbles below its cover. A simple connection to the top of this dome 34a allows the collected gas to be returned. This feature is especially effective in producing a greater quality and quantity of mini microbubbles and it is simple, effective, easy and inexpensive to implement.

In the present invention, multiple benefits are achieved. First, since oxygen enhances the treatment of waste water and promotes the action of the aerobic bacteria in the waste water, the generated oxygen produced by the algae is delivered for use in the waste water treatment system. As such, the effectiveness of waste water treatment is enhanced by the process of the present invention. Additionally, since the growth of algae is strongly promoted by introducing carbon dioxide to the algae, the growth of the algae is strongly promoted by the system of the present invention. The carbon dioxide byproduct of waste water treatment is delivered to the algae in a closed and effective system. As such, the present invention not only produces enhanced growth of algae but also produces enhanced treatment of waste water.

The use of the mini microbubbles of the present invention further enhances the treatment of the waste water and the algae. Mini microbubbles easily flow, rapidly diffuse, and linger within a liquid in the waste water treatment tank and in the algae tank. Because gas transfer to liquids is a function of the ratio of surface area to volume, the smaller mini microbubbles have a greater transfer potential and are better for aeration. The use of the aerator of the present invention creates strong cavitation in agitation forces. As such, the mini microbubbles aggressively provide oxygen to the aerobic bacteria in the waste water tank and provide carbon dioxide to the algae in the algae tank. The mini microbubbles maximize the amount of surface area of the oxygen exposed to the aerobic bacteria and the carbon dioxide exposed to the algae.

Within the concept of the present invention, it has been found that the aggressive delivery of carbon dioxide, through the use of the mini microbubbles, to the algae enhances the hydrocarbon byproducts of the algae. The agitation and cavitation resulting from the aeration means of the present invention has been found to stimulate the algae so that the algae are effectively compressed within the tank so as to enhance the hydrocarbon production from the algae as the algae is delivered from the algae tank.

The foregoing disclosure and description of the invention is illustrative and explanatory thereof. Various changes in the details of the described system, along with the steps of the described method, can be made within the scope of the appended claims without departing from the true spirit of the invention. The present invention should only be limited by the following claims and their legal equivalents.

I claim:

1. A system for algae production comprising:
a first tank having an interior containing aerobic bacteria and waste water therein;
a first aeration means cooperative with said interior of said first tank for passing bubbles into the waste water and the aerobic bacteria in said interior of said first tank;
a first collection chamber positioned above said first tank, said first collection chamber suitable for collecting carbon dioxide from a reaction of the aerobic bacteria with the waste water;
a second tank having an interior having algae and water therein; and
a second aeration means in fluid communication with said first collection chamber, said second aeration means for passing carbon dioxide from said first collection chamber as bubble into said algae and said water in said interior of said second tank.

2. The system of claim 1, said first tank having an inlet connected thereto so as to pass waste water into said interior of said first tank, said first tank having an outlet connected thereto so as to pass treated effluent from said first tank.

3. The system of claim 1, said first aeration means for passing vacuum bubbles and/or mini microbubbles into the waste water and aerobic bacteria in said interior of said first tank.

4. The system of claim 1, further comprising:
a second collection chamber positioned above said second tank so as to collect oxygen produced from the algae in said interior of said second tank.

5. The system of claim 4, said second collection chamber being in fluid communication with said first aeration means, said first aeration means for passing bubbles of oxygen into the waste water and aerobic bacteria in said interior of said first tank.

6. The system of claim 1, said second tank having an outlet connected thereto so as to pass algae solids from said interior of said second tank.

7. The system of claim 1, said second aeration means for passing vacuum bubbles or mini microbubbles of carbon dioxide into the algae and water in said interior of said second tank.

8. The system of claim 1, said first aeration means supported by a float on a surface of the waste water in said first tank, said second aeration means supported by a float on a surface of the water in said second tank.

9. A system for treating waste water comprising:
a first tank having an interior containing aerobic bacteria and waste water therein;
a first aeration means cooperative with an interior of said first tank;
a second tank having an interior containing algae and water therein;
a collection chamber positioned above said second tank so as to collect oxygen as produced from the algae in said second tank, said first aeration means being in fluid communication with said collection chamber so as to pass bubbles of oxygen into said waste water in said interior of said first tank.

10. The system of claim 9, said first aeration means for passing mini microbubbles of oxygen into the waste water and aerobic bacteria in said interior of said first tank.

11. The system of claim 9, said first tank having an inlet connected thereto so as to pass waste water into said interior of said first tank, said first tank having an outlet connected thereto so as to pass treated effluent from said first tank.

12. The system of claim 9, further comprising:
another collection chamber positioned above said first tank so as to collect carbon dioxide from a reaction of waste water and aerobic bacteria within said first tank.

13. The system of claim 12, further comprising:
a second aeration means in fluid communication with said another collection chamber, said second aeration means for passing bubbles of carbon dioxide into the water in said second tank.

14. The system of claim 13, said second aeration means for passing mini microbubbles of carbon dioxide into the water in said second tank.

15. The system of claim 9, said second tank having an outlet connected thereto so as to pass algae solids from an interior of said second tank.

16. A process for algae production comprising:
reacting waste water with aerobic bacteria and oxygen so as to produce carbon dioxide;
passing the produced carbon dioxide into water having algae therein so as to grow the algae; and
removing the grown algae from the water.

17. The process of claim 16, further comprising:
collecting oxygen from the algae; and
mixing the collected oxygen with the waste water and aerobic bacteria.

18. The process of claim 16, the step of passing the produced carbon dioxide comprising:
introducing mini microbubbles of the produced carbon dioxide into the water having algae therein.

19. The process of claim 16, further comprising:
collecting the produced carbon dioxide into a collection chamber;
connecting the collection chamber to an aerator; and
aerating the algae and water with the collected carbon dioxide.

20. The process of claim 17, further comprising:
removing the reacted waste water so as to produce a treated effluent.
